(19) United States
(12) Patent Application Publication
(10) Pub. No.: US 2013/0283629 A1
(43) Pub. Date: Oct. 31, 2013

(54) DRYER, ESPECIALLY HAND DRYER

(71) Applicant: USHIO EUROPE B.V., Oude Meer (NL)

(72) Inventor: Nils BUEKER, Oude Meer (NL)

(73) Assignee: Ushio Europe B.V., Oude Meer (NL)

(21) Appl. No.: 13/867,352

(22) Filed: Apr. 22, 2013

(30) Foreign Application Priority Data
Apr. 25, 2012 (DE) 10 2012 008 253.3

(51) Int. Cl. F26B 20/00

(52) U.S. Cl. CPC F26B 20/00
USPC 34/60; 34/523

(57) ABSTRACT

A dryer comprising a housing in which there is a hollow space which is accessible from outside through a housing port and which serves to accommodate extremities, more particularly hands, to be dried by means of a current of air, and in which a device for generating the current of air is present. The dryer also includes a means for reducing germs in the current of air, such as a plasma or ion source, or a radiation source such as UV emitter or dielectric barrier discharge lamp.

### BACKGROUND OF THE INVENTION

1. Field of the Invention

The invention relates to a dryer, more particularly a hand dryer, in which extremities, more particularly hands, inserted through a housing port can be dried in a hollow space by means of a current of air.

2. Description of Related Art

Hand dryers are basically known in the art. They usually comprise a fan or a blower that blows air through one or more nozzles towards the hands positioned in the hollow space for the purpose of drying the hands. For example, a hand dryer is described in WO 2007/015040 A1, in which a current of air in the form of a thin air curtain is blown through slot shaped nozzles towards the hands at a high velocity. The liquid blown off the hands is collected in a fluid collecting area. On the other hand, the air used for drying is recirculated, in part, within the dryer and flows, in part, into the environment of the dryer. Contaminants clinging to the hands and, in particular, germs such as spores or bacteria may be entrained by the air in this way and can thus pass into the surrounding atmosphere.

In many fields, the accumulation of contaminants and, in particular, germs, in the air is undesirable or even prohibited. For example, reference may be made in this context to hospitals or residential care homes for the elderly, production plants in which stringent demands for clean environmental conditions are imposed, for example, in the production of pharmaceuticals or foodstuffs, or in gastronomy. Irrespective of these particular instances, an increased demand for satisfactory hygienic conditions is now a general trend.

In addition to environmental contamination control, it is also necessary in many fields to disinfect or even sterilize extremities, i.e., more particularly the hands, and possibly also the arms of the personnel who work in such fields. Disinfection or sterilization is usually carried out by washing with germicidal substances, for example, liquid or gel-like alcohol-based compositions. However, thorough disinfection or sterilization necessitates a very laborious procedure that is time-consuming. In many cases, the disinfecting or sterilizing action is not sufficiently complete, which entails the risk of infection by germs remaining on the extremities.

Accordingly, it is an object of the invention to provide a dryer, which at least reduces the quantity of germs in the current of air recirculated during the drying procedure and/or in the current of air passing into the environment, and which can be used, if desired, for the disinfection and/or sterilization of extremities, particularly the hands and optionally the arms, positioned therein.

### SUMMARY OF THE INVENTION

This object is achieved by means of a dryer comprising a housing, in which there is a hollow space that is accessible from the outside through a housing port. This hollow space serves to accommodate extremities, in particular the hands, for the purpose of drying the same. Furthermore, a device is provided for the purpose of generating a current of air used for drying the extremities positioned in the hollow space. Additionally, the dryer of the invention comprises a means capable of reducing the quantity of germs present in the current of air. This means ensures that germs entrained, in particular, by the current of air blown towards the extremities to be dried are killed. Therefore, the germs entrained by the current of air will no longer be likely to pass into the environment of the dryer or to return to the extremities of the user due to recirculation of the current of air within the dryer.

Basically, all suitable germ reducing means may be used as the means for the reduction of germs in the current of air. For example, means are suitable that dispense a germ reducing or germicidal substance (referred to below for the sake of simplicity as a germ reducing substance) into the current of air. There are basically no restrictions on the types of germ reducing substance used, although substances that might be harmful to the health of the user of the dryer must naturally be avoided. Advantageously, the germ reducing substance is metered to the current of air by spraying, atomizing, or blowing the same into the current of air. Suitable supply means such as nozzles are known in the art and need not be described in detail at this juncture. Advantageously, the germ reducing substance is supplied in liquid or gaseous form. The use of at least one alcohol or of an alcoholic solution or of a gas containing ozone and/or free radicals is very preferable.

As a further means for the reduction of germs in the current of air, use can be made of a source of plasma or ions, preferably a microwave or radio frequency source. Such sources result in the production of plasma or ionized gas in the current of air, which plasma or ionized gas has intrinsically a germicidal effect. In addition, reactive compounds such as the aforementioned ozone or free radicals, which likewise have a germicidal effect, are formed in secondary steps.

Sources of radiation may be used as a further means for the reduction of germs in the current of air. On the one hand, it is possible to use sources of radiation, the radiation of which has intrinsically a germicidal effect, or on the other hand to use sources of radiation, the radiation of which results in the formation of germicidal compounds. Sources of radiation emitting ultraviolet radiation may be mentioned as an example of the first possibility. Dielectric barrier discharge lamps, the operation of which results in the formation of reactive plasma, are an example of the second possibility.

All of the means described above result directly or indirectly in the reduction of germs in the current of air formed within the dryer of the invention. By causing the current of air inside the dryer to be guided in a suitable manner and by appropriately disposing the means for the reduction of germs in the current of air, it is possible to predetermine whether the germicidal means will act directly on the extremities to be dried or will merely sterilizes the current of air leaving the extremities. For example, it is possible to implement the means for the reduction of germs such that it dispenses germicidal substances exclusively into the current of air leaving the dried extremities, either by the provision of an external supply of a germicidal substance or by causing the same to be generated in the current of air by means of radiation or a source of plasma or ions. If the current of air enriched with germicidal substances is not recirculated to the drying chamber, the user's extremities to be dried do not come into contact with the germ reducing substances. Furthermore, the escape of germ reducing substances into the environment of the dryer may be prevented or at least reduced by filtering the substance out of the current of air or by causing it to degrade with the formation of harmless decomposition products. A filter may also be used for collecting the killed germs.

If, however, the dryer of the invention is also to be used for disinfection and/or sterilization of the extremities, the germ reducing substances are supplied to the hollow space in which the process of drying takes place. This may be carried into effect, for example, by causing the air enriched with germ reducing substances to be supplied to the hollow space, for example, by recirculation, or by causing germ reducing substances to be produced in the hollow space. If the means for the reduction of germs is a source of radiation which itself has a germicidal effect, i.e., for example, a UV emitter, it is advantageously disposed in the hollow space in such a way that its radiation is emitted towards the extremities positioned in the hollow space. Combinations of the possibilities described above are also feasible.

In principle, the basic construction of the dryer of the invention may be similar to the construction of conventional dryers and differs from the latter only in the use of the means for the reduction of germs in the current of air. Therefore, it is also possible, in principle, to retrofit conventional dryers by the provision of a germ reducing means so as to achieve the advantages of the invention. According to the invention, preference is given to dryers, the basic construction of which is similar to that described in WO 2007/015040 A1. This relates, in particular, to the supply of air to the drying chamber. According to the invention, use is likewise preferably made of flat nozzles for this purpose, by means of which thin air curtains are blown at a high velocity towards the extremities to be dried. Advantageously, a dryer of the invention thus comprises two flat nozzles, which are located opposite each other at the longitudinal side walls of the housing port and by means of which the current of air is blown into the hollow space. It has proved to be very advantageous when the nozzle orifices are disposed at an angle of inclination of at least 7° relative to the port area of the housing port. In this way, the air blown into the hollow space is guided obliquely at a relatively small angle towards and along the extremities to be dried. The device used for generating the current of air may be a blower or a fan, as employed in known manner.

In principle, the current of air may likewise be guided in the dryer in known manner. It is preferred that at least a portion of the air blown into the hollow space for drying the extremities be recirculated to the hollow space. For this purpose, the dryer of the invention comprises at least one air exhaust duct and at least one air supply duct that communicate with the hollow space such that the current of air may be circulated through the air exhaust duct, the air supply duct, and the hollow space. The device for generating the current of air, such as a blower or a fan, may basically be disposed at any desired location within this ventilation path, that is to say, in the air exhaust duct, in the air supply duct or in the region of the hollow space. It is preferred to place the device for generating the current of air in the region of the air exhaust duct, where the current of air is withdrawn from the hollow space.

As described above, there are various options for the position of the means for the reduction of germs in the current of air. In this regard, said means might also be disposed in the air exhaust duct, in the air supply duct, or in the region of the hollow space. Again it is particularly preferred that the means be disposed in the region of the air exhaust duct.

Since it is an aim of the invention to prevent the passage of germs from the region of the dryer into its environment as far as possible, it is preferred to provide the dryer of the invention with a largely closed design. Hand dryers known hitherto, for example, the one described in WO 2007/015040 A1, have, by contrast, a relatively open design serving the purpose of preventing the build-up of dynamic pressure and of allowing the air to escape rapidly. For this reason, for example, the hollow space designed for drying the hands is open at the sides of the hand dryer. By contrast, the housing of the dryer of the invention has a largely closed design to an extent deemed possible without adversely affecting the operation of the dryer. This ensures that a minimum amount of air will escape from the dryer of the invention without having passed the means for the reduction of germs. Specifically, the housing port providing access to the hollow space for the extremities to be dried is configured in such a way, on the one hand, that its port area constitutes less than 20% of the total surface area of the hollow space. The term “total surface area of the hollow space” refers, in this case, to the virtual surface area of the hollow space, which includes the external surfaces of the hollow space that are not enclosed by a housing wall. Accordingly, the port area of the housing port is also included in the total surface area of the hollow space. The same holds true for open lateral or bottom regions of the hollow space that are not closed by a wall. As regards the total surface area of the open regions of the hollow space, it is preferred that more than 25% of the total surface area of the hollow space be enclosed by the housing. Similarly, the expression “virtual total surface area of the hollow space” has the meaning described above. More preferably, more than 35%, and even more preferably, more than 50% of the total surface area of the hollow space is enclosed by the housing.

The invention is explained in greater detail below with reference to the drawings. Like components are designated by like reference characters in the purely schematic representations, in which:

### BRIEF DESCRIPTION OF THE DRAWINGS

FIGS. 1 to 3 each show the cross-section of an exemplary embodiment of a dryer of the invention with reference to a hand dryer;

FIG. 4 is a partial cross-section of an air supply duct at its transition region to the hollow space, on an enlarged scale;

FIG. 5 is a further cross-sectional view of a dryer of the invention for illustrating the port areas in the region of the hollow space; and

FIG. 6 is a simplified perspective view of the hollow space illustrating the total surface area thereof.

### DETAILED DESCRIPTION OF THE INVENTION

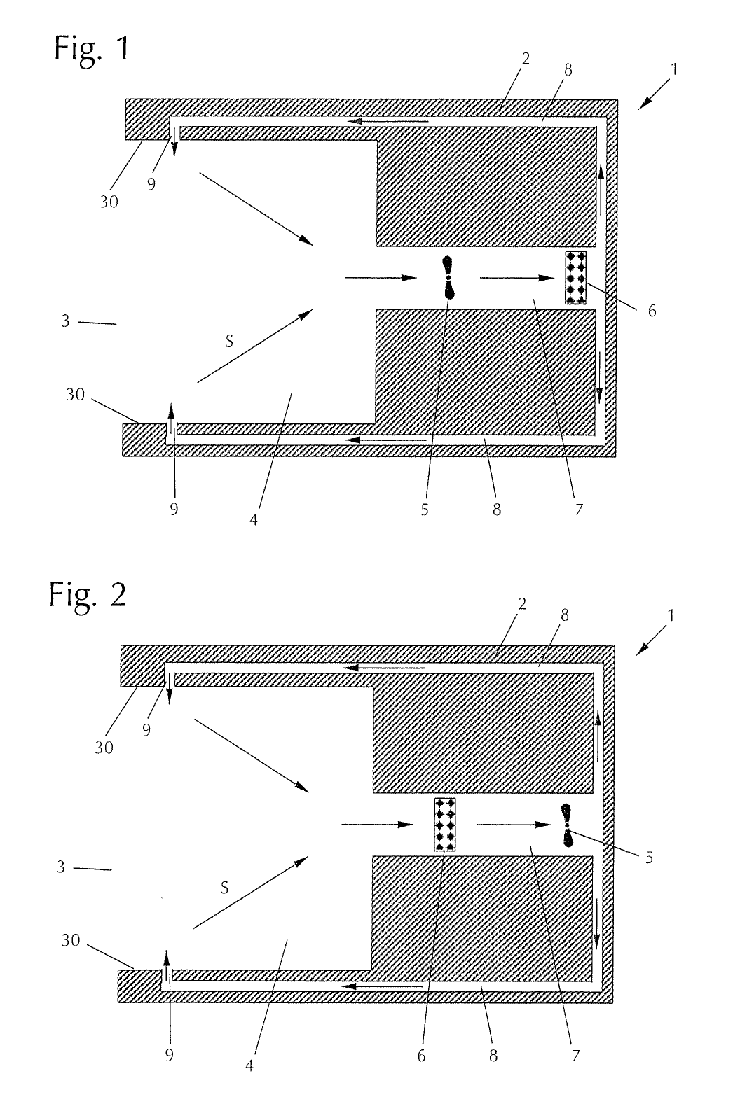

FIG. 1 is a cross-sectional view of a hand dryer 1 of the invention and shows a cross-section in the region of its hollow space 4, which cross-section is taken at right angles to the longitudinal sides 30 of the housing port 3, through which the hands to be dried are inserted into the hollow space 4. The hands are positioned side-by-side in the housing port 3 in a manner known per se from hand dryers in such a way that the backs and palms of the hands are aligned to each other and are adjacent to the respective longitudinal sides 30 of the housing port 3. Thus the cross-sectional view shown in the figure and also the other cross-sectional views correspond to a direction extending at right angles to the palms of the hands in the positioned state of the hands in the hollow space 4.

The dryer 1 of the invention is substantially enclosed by a housing 2 with the exception of the housing port 3. The hollow space 4 mentioned above for the accommodation of the hands to be dried and ducts for guiding the current of air within the dryer 1 are located within the housing 2. In particular, an air exhaust duct 7 extends away from the hollow space 4 and opens into two air supply ducts 8 leading back past the hollow space 4 towards the housing port 3. The ends of the air supply ducts 8 are in the form of two slot nozzles 9. These slot nozzles 9 extend substantially over the entire length of the lateral edges 30 of the housing port 3. A thin air curtain is blown through the slot nozzles 9 at a high velocity towards the hands to be dried and positioned in the hollow space 4.

For the purpose of generating the current of air illustrated by the arrows designated by S, there is provided a fan 5 in the region of the air exhaust duct 7. The operation of this fan 5 causes air to be withdrawn from the hollow space 4 towards the air exhaust duct 7, whence it is transferred to the air supply ducts 8 and then forced back into the hollow space 4 by way of the slot nozzles 9. In principle, it is possible to circulate substantially the entire current of air through the dryer 1. Alternatively, only a portion of the current of air S may be recirculated in the dryer 1, while another portion is returned to the environment of the dryer 1 through outlet ports (not shown).

In order to prevent germs entrained by the current of air from returning to the hollow space 4 or from passing into the environment of the dryer 1, a means 6 for the reduction of germs is provided in the air exhaust duct 7. The means 6 is positioned such that substantially all of the air withdrawn from the hollow space 4 and supplied to the air exhaust duct 7 will flow into the region of action of the means 6 for the reduction of germs. Said means 6 may be a plasma source or an ion source that generates plasma or ionized gas in the region of the air exhaust duct 7, which plasma or ionized gas consequently kills the germs entrained by the current of air. Alternatively, use may be made of a source of radiation, the radiation of which either kills germs directly, for example, by the emission of ultraviolet radiation, or the operation of which results in the formation of reactive compounds in the current of air, for example, the formation of ozone, reactive ionized compounds or free radicals. In a further variant, the means 6 for the reduction of germs may be a means for dispensing a germ reducing substance. For example, the means 6 may be a nozzle that communicates with a reservoir (not shown) containing the germ reducing substance and that dispenses this substance into the current of air.

The germ reducing substances dispensed directly into the current of air by the means 6 for the reduction of germs, or the substances formed in the environment of the means 6 are entrained by the current of air and conveyed through the air supply ducts 8 and the nozzles 9 into the hollow space 4. Here they come into contact with the hands positioned in the hollow space and thus assist in disinfecting or even sterilizing the hands.

FIG. 2 shows an alternative embodiment of a dryer of the invention that is distinguished from that shown in FIG. 1 by the position of the means 6 for the reduction of germs and the device 5 for generating the current of air. Here the means 6 for the reduction of germs is disposed upstream of the fan 5 as regarded in the direction of flow. The mode of operation, however, is, in all, equivalent to that of the dryer illustrated in FIG. 1.

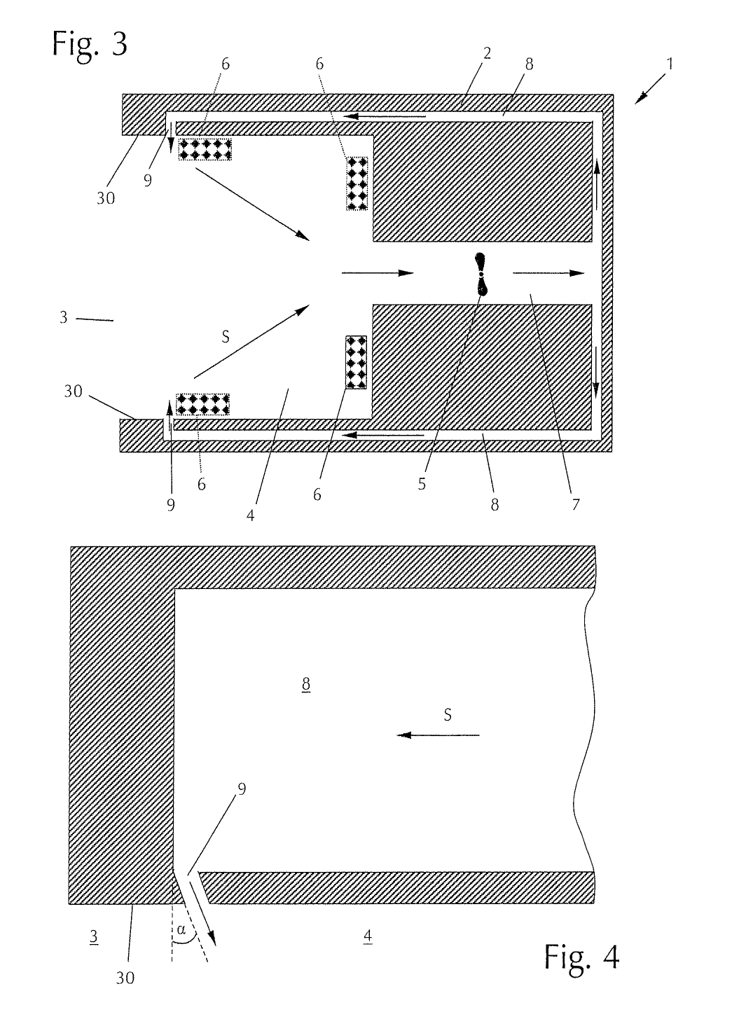

A further possible arrangement of the means 6 for the reduction of germs in the current of air is shown in FIG. 3. Here, the means 6 is disposed in the hollow space 4, for example in a region of the hollow space 4 that is remote from the housing port 3. Additionally or alternatively, the means 6 indicated by the dotted outline may be mounted in the hollow space 4. The provision of the means 6 in the hollow space 4 is suitable particularly for means 6, the germ reducing action of which is based, for example, on the emission of germicidal radiation towards the hands to be dried and positioned in the hollow space 4. Thus the means 6 may be a UV emitter, for example. Of course, it is likewise possible to provide the means 6 in the housing at a position adjacent to the hollow space 4. In order to allow the passage of radiation emitted by the means 6 into the hollow space 4, a window or an opening may be provided to allow communication with the hollow space.

FIG. 4 is a partial cross-section, on an enlarged scale, of the region of the end of an air supply duct 8 and the nozzle 9 that communicates with the air supply duct and opens into the hollow space 4. As shown in the figure, the nozzle 9 is disposed so as to be at an angle to the port area of the housing port 3. The nozzle 9 is angularly disposed such that the current of air S is fed by the nozzle 9 obliquely into the interior of the hollow space 4. The angle of inclination α, at which the mouth of the nozzle 9 and thus the current of air leaving the nozzle 9 extends obliquely relatively to the port area of the housing port 3, is preferably at least 7°. In this way, the current of air is blown obliquely from the rear towards the hands positioned in the hollow space, and the current of air removes the moisture clinging to the hands by blowing from the rear to beyond the fingertips. The liquid blown from the hands may be drained off in a manner known in the art and collected in a fluid collecting area or a fluid receiver vessel.

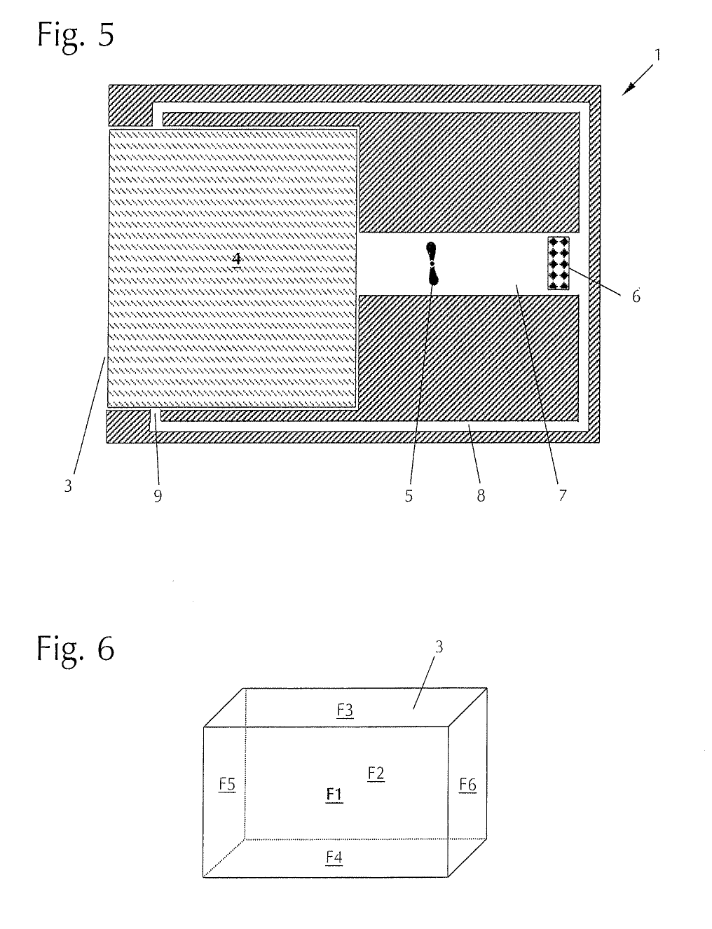

Unlike the prior art, the dryer of the invention is of a largely closed design. Thus the housing 2 usually seals a larger region of the dryer from the environment than is the case in the prior art. While a relatively open design is preferred in the prior art in order to prevent the build-up of a dynamic pressure in the device, it is preferable, according to the present invention, for the largest possible portion of the current of air to be kept within the dryer 1, in order to prevent air contaminated by germs from flowing into the environment of the dryer without having passed the means 6 for the reduction of germs. FIGS. 5 and 6 serve to illustrate the extent to which the hollow space 4 is enclosed by the housing. The hollow space 4 is shown here in an idealized form as a cube. However, the following aspects apply similarly to more complicated shapes of the hollow space 4. The total surface area of the hollow space 4, that is, the total surface area of the cube as shown in FIG. 6, is the sum of the surface areas F1, F2, F3, F4, F5, and F6. This is thus a virtual total surface area, since not all of the surfaces are covered completely by the housing 2. The areas of the open regions, for example, the housing port 3 having the area F3 are included in the total surface area of the hollow space 4. In the case of more complicated shapes of the hollow space, the regions that are not closed are added thereto as being surface areas by means of which the open regions could be closed with the least possible expanse of surface.

According to the invention, it is preferable, on the one hand, that the port area F3 of the housing port 3, which provides access to the hollow space 4 for the hands to be dried, should have the least possible area. Thus it is only large enough to allow the hands to access the hollow space 4 in a convenient manner. Advantageously, the port area F3 of the housing port constitutes less than 20% of the total surface area (F1+F2+F3+F4+F5+F6) of the hollow space 4. The total open area of the hollow space 4, i.e. that of all of the open areas, in addition to the housing port 3, by means of which the hollow space is open to the environment of the dryer 1, is preferably less than 75% of the total surface area of the hollow space. Conversely, more than 25% of the total area of the hollow space 4 is enclosed by the housing 2. Preferably, the housing encloses more than 35% and especially preferably more than 50% of the hollow space. This not only improves the efficiency of flow guidance within the dryer 1 but also prevents air that may be contaminated to a major extent by germs from being able to escape from the dryer 1 before it has passed the means 6 for the reduction of germs.

What is claimed is:

1. A dryer comprising a housing, in which there is a hollow space which is accessible from outside through a housing port and which serves to accommodate extremities, more particularly hands, to be dried by means of a current of air, and in which a device for generating said current of air is present, the dryer further including a means for the reduction of germs in said current of air.

2. The dryer as defined in claim 1, wherein said means for the reduction of germs is selected from the group consisting of
a device for dispensing a germ reducing substance into said current of air,
a source of plasma or ions, and
a source of radiation.

3. The dryer as defined in claim 2, wherein said germ reducing substance is liquid or gaseous and is more particularly selected from the group consisting of
at least one alcohol or alcoholic solution and
a gas containing ozone and/or free radicals.

4. The dryer as defined in claim 2, wherein said source of plasma or ions is a source of plasma or ions that is stimulated by microwaves or radio frequencies.

5. The dryer as defined in claim 2, wherein said source of radiation is a UV emitter or a dielectric barrier discharge lamp.

6. The dryer as defined in claim 1, wherein it comprises at least one exhaust duct and at least one air supply duct, which communicate with said hollow space such that said current of air is capable of being circulated through said exhaust duct, said air supply duct, and said hollow space.

7. The dryer as defined in claim 6, wherein said device for generating said current of air is disposed in said exhaust duct, in said air supply duct, or in the region of said hollow space and is more particularly disposed in the region of said exhaust duct.

8. The dryer as defined in claim 6, wherein said means for the reduction of germs is disposed in said exhaust duct, in said air supply duct, or in the region of said hollow space and is more particularly disposed in the region of said exhaust duct.

9. The dryer as defined in claim 1, wherein the port area of said housing port is less than 20% of the total surface area of said hollow space.

10. The dryer as defined in claim 1, wherein the total surface area of said hollow space is enclosed by said housing to an extent of more than 25%, preferably more than 35% and more preferably more than 50%.

11. The dryer as defined in claim 1, wherein said current of air is blown into said hollow space through at least one nozzle, more particularly through two flat nozzles disposed opposite each other at the longitudinal side walls of said housing port, wherein the angle of inclination (α) between the nozzle orifice and the port area of said housing port is preferably at least 7°.
